(19) United States
(12) Patent Application Publication
(10) Pub. No.: US 2004/0001439 A1
(43) Pub. Date: Jan. 1, 2004

(54) System and method for data routing for fixed cell sites

(76) Inventor: Bryce A. Jones, Overland Park, KS (US)

Correspondence Address: Steven J. Funk, Sprint Corporation, 8140 Ward Parkway, Kansas City, MO, 64114, US

(21) Appl. No.: 10/008,134

(22) Filed: Nov. 8, 2001

(51) Int. Cl. H04L 1/00

(52) U.S. Cl. 370/235; 370/329

(57) ABSTRACT

An intelligent switching system and method provides an alternate, least-cost telecommunications link (which may be a wireless link) between a base transceiver station (BTS) and a base station controller (BSC) in a radio access network (RAN). Signals may be routed via the alternate telecommunications link or via an existing telecommunications link based on the sensitivity of the signals to transmission latency. The switching system may determine the sensitivity of the signals to transmission latency.

### BACKGROUND OF THE INVENTION

1. Field of the Invention

The present invention relates to wireless telecommunications, and more particularly to methods and systems of routing traffic in a wireless telecommunications network.

2. Description of Related Art

In a typical cellular radio communications system (i.e., a wireless telecommunications network), an area is divided geographically into a number of cell sites, each defined by a radio frequency (RF) radiation pattern or air interface from a respective base transceiver station (BTS) antenna. A number of mobile stations (such as cellular telephones, personal digital assistants (PDAs) and/or other devices) may operate concurrently in a given cell site, all communicating via the air interface with a common BTS. In turn, the BTSs from a number of cell sites may communicate concurrently with a common base station controller (BSC), which may function to aggregate and control traffic for the multiple BTSs. A number of BSCs may then communicate concurrently with a common gateway, such as a packet data serving node (PDSN) or mobile switching center (MSC), which may function to set up and connect communications to or from other entities. The BTS, BSC and gateway, in combination, comprise a radio access network (RAN) that provides network connectivity for a mobile station.

In practice, bearer traffic (i.e., the communications that travel from one user to another, exclusive of signaling information) may travel from a mobile station to a BTS according to a well known protocol, such as CDMA, TDMA, AMPS, etc. The BTS may then aggregate traffic from a number of mobile stations and transmit the traffic in a time-division multiplexed (TDM) stream or in some other form to a BSC. The BSC may similarly aggregate traffic from a number of BTSs and transmit the traffic in a TDM stream or other form to a gateway for transmission to a remote entity. Conversely, when traffic is being transmitted to a mobile station, the traffic may pass from a gateway to a BSC, to a BTS and on to the mobile station.

With the explosive growth in popularity of wireless communications, a significant need has arisen to increase the traffic capacity of wireless communication networks. The main focus in this regard has been the air interface. Today, the most common CDMA protocol for air interface communications, IS-95, can support up to 64 concurrent communications sessions (each encoded with a respective Walsh code, of 64 Walsh codes), each at up to 64 kilobits per second (Kbps). The industry, however, is beginning to embrace higher bandwidth air interface protocols, such as cdma2000 1×RTT (also known as 1XMC), which may support up to 144 kbps (by using each Walsh code twice), and cdma2000 HDR (High Data Rate), which may support up to 621 kbps. Further, mobile station manufacturers are also now producing mobile stations that can send and receive multimedia communications in digital format, such as graphics and video (in addition to voice), which further increases the demand for high bandwidth.

As traffic capacity on the air interface increases, the other entities and links in the wireless communications network must also be capable of supporting the increased traffic flow. Unfortunately, bottlenecks exist. For instance, if a BTS is to support a number of concurrent high-bandwidth communications with mobile stations, the link between the BTS and the BSC must support all of that traffic at once. The link between a BTS and BSC, though, is typically a transmission line with a fininte bandwidth. Similarly, the link between the BSC and a gateway such as a PDSN or MSC is typically a transmission line with a finite bandwidth. It is possible to increase traffic capacity between various network elements by simply adding more transmission lines. Adding transmission lines, though, can be very expensive, since it requires a provider to either physically add the lines, or to lease additional lines from a local exchange carrier (LEC). Leasing lines from LECs to increase the traffic capacity between network elements can, in fact, be a significant portion of a cellular provider's total operating cost. Thus, an even better solution for increasing traffic capacity would be desirable.

### SUMMARY OF THE INVENTION

According to an exemplary embodiment of the present invention, a method and system is provided for supporting increased traffic over links in the RAN, such as the BTS-BSC link (or the BSC-MSC/PDSN link). In the exemplary embodiment, the BTS can remain coupled to the BSC by a conventional transmission line, but the BTS may also be communicatively coupled with the BSC by a satellite link or by another wireless link.

According to the exemplary embodiment, delay-sensitive communications may be routed via the landline transmission link between the BTS and BSC, but other communications (i.e., those that are not delay sensitive) may be routed via a supplemental satellite link (or other link) between the BTS and the BSC. Advantageously, this arrangement will free up bandwidth on the landline link that would have otherwise been used to carry voice and data transmissions, and the alternatively routed data transmissions will still reach their destination, possibly with greater latency. The result will be an increase in overall bandwidth in the RAN, thereby allowing support for the latest high-bandwidth communications.

To facilitate carrying out the invention, the BTS and BSC can each be communicatively linked with satellite transceivers and can contain logic to determine whether a given communication is delay-sensitive. Communications subject to routing decisions within the system may be in the form of IP packets. Alternate routing of communications can be based on inspecting properties within the IP packets that can indicate whether they are delay-sensitive. The inspected properties may include, for example, source and destination address, the contents of the payload, the IP port addresses, the protocol of the packets, type-of service (TOS) flags, etc. The logic used for routing may comprise a processor and a set of code executable by the processor, or it may comprise a hardware-implemented multilayer switch or another type of packet switch. Based on the inspection, the logic may establish whether the communication should be routed via the landline link or the satellite link.

For instance, upon initiation of a given communication session from a mobile station, the BTS may receive an origination-request signaling message that includes a parameter indicating whether the attempted communication is real-time media or data-only (and not real-time) media. If the parameter indicates the communication is real-time media, the logic may conclude that the communication is delay sensitive. Consequently, the BTS may route the traffic via the landline link to the BSC. On the other hand, if the parameter indicates that the communication is data-only, the logic may conclude that the communication is not delay-sensitive. Thus, the BTS may route the traffic via the satellite link to the BSC. The same holds true for communications from the BSC to the BTS, and over other such links (e.g., the BSC-MSC link or BSC-PDSN link).

As is known in the art, satellite and other wireless communications may delay communications. This increased latency can be problematic for real-time media communications, such as voice or videoconferences, for instance, as the added delay can perceptibly disrupt the communication. However, added latency is largely irrelevant for data-only or one-way communications, such as text messages, file transfers, or one-way streaming video or audio. If such communications reach their destination even several seconds later than they would otherwise, but in a substantially continuous sequence, the recipient will likely not know the difference (or won't care). Thus, by using the method and apparatus of the exemplary embodiment, the capacity of a radio access network (RAN) can be increased without the prohibitively expensive cost of adding or leasing additional transmission lines, such as copper lines. Moreover, no one using a network that employs the invention is likely to perceive any difference in overall quality as compared to a conventional RAN. In fact, under certain circumstances, a network that uses the present invention may improve real-time media quality.

These and other features and advantages of various embodiments of the invention will be more completely described below in the detailed description of an exemplary embodiment section.

### BRIEF DESCRIPTION OF THE DRAWINGS

Exemplary embodiments of the present invention are described herein with reference to the drawings, in which:

FIG. 1 is a simplified block diagram illustrating a portion of a telecommunications network in which an exemplary embodiment of the present invention can be implemented;

FIG. 2 is a simplified block diagram illustrating an exemplary embodiment of the present invention;

FIG. 3 is a simplified block diagram illustrating an alternative exemplary embodiment of the present invention;

FIG. 4 is a simplified block diagram illustrating another alternative exemplary embodiment of the present invention; and

FIG. 5 is a flow chart illustrating the operation of an exemplary embodiment of the present invention.

### DETAILED DESCRIPTION OF AN EXEMPLARY EMBODIMENT

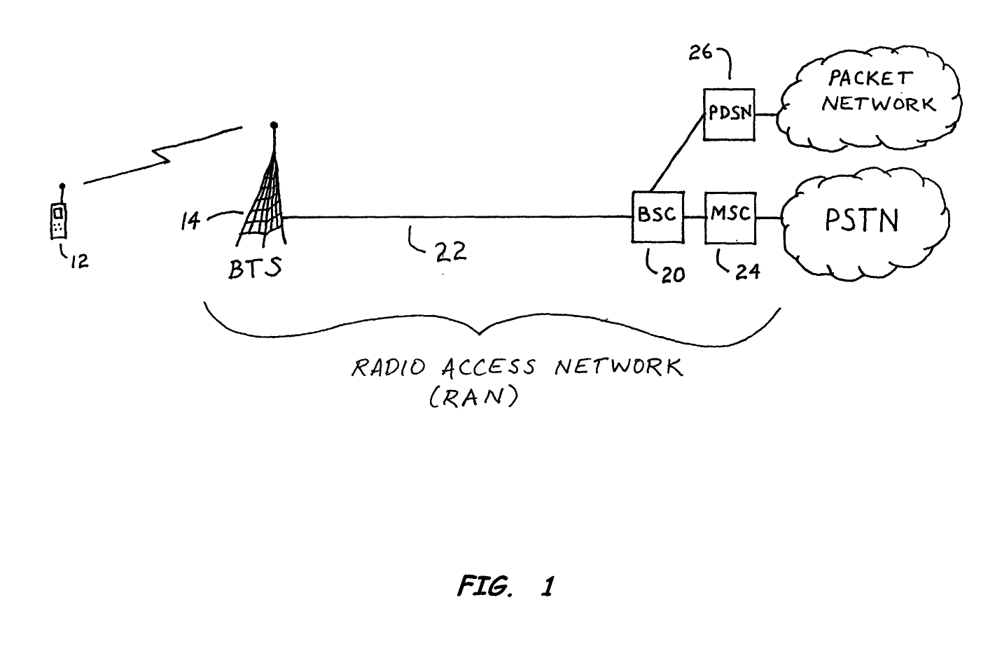

Referring to the drawings, FIG. 1 illustrates a simplified block diagram of a telecommunications network in which an exemplary embodiment of the present invention may be employed. As shown in FIG. 1, the network may include a radio access network (RAN) that comprises various network nodes, such as a base transceiver station (BTS) 14, a base station controller (BSC) 20, and a common gateway such as mobile switching center (MSC) 24 or a packet data serving node (PDSN) 26, such as a Commworks® Total Control 1000 Packet Data Serving Node or the like. MSC 24 may be a Motorola or Nortel MSC or any other suitable MSC. The arrangement and functionality of these components are well known in the art and therefore will not be described here in detail.

MSC 24 may serve as an interface between BSC 20 and the public switched telephone network (PSTN) 28. Similarly, PDSN 26 may serve as an interface between BSC 20 and an IP network 30, such as a mobile internet or the Internet. It is not necessary that BSC 20 and MSC 24 be separate entities, since the functionality of both a BSC and an MSC could be integrated into one unit.

Within the telecommunications network, multiple communications devices, such as mobile station 12, may be communicatively coupled with BTS 14. Although mobile station 12 is shown as a wireless telephone, it may take any suitable form, such as (without limitation) a wireless modem, a wireless PDA, or a two-way pager. Mobile station 12 may communicate with BTS 14 using an air interface as set forth in TIA/EIA-95 or TIA/EIA/IS-2000. Alternatively, mobile station 12 could be part of a cellular system that uses another technology, such as AMPS, TDMA, DECT, GSM, PCS, or PWT; the cellular technology used is not necessarily critical to the functioning of the present invention.

For clarity only, multiple network entities, such as BTSs and BSCs, have been omitted from the drawings, although normally a network in which the invention may be implemented would include, for example, more than one BTS, MSC, mobile station, etc.

Typically, BTS 14 would be communicatively linked to BSC 20 via a first communication link such as a dedicated, circuit-switched transmission line, shown as transmission line 22a in FIG. 1. Transmission line 22 could be (or could include, without limitation), a copper wire, a fiber optic link, or a microwave link.

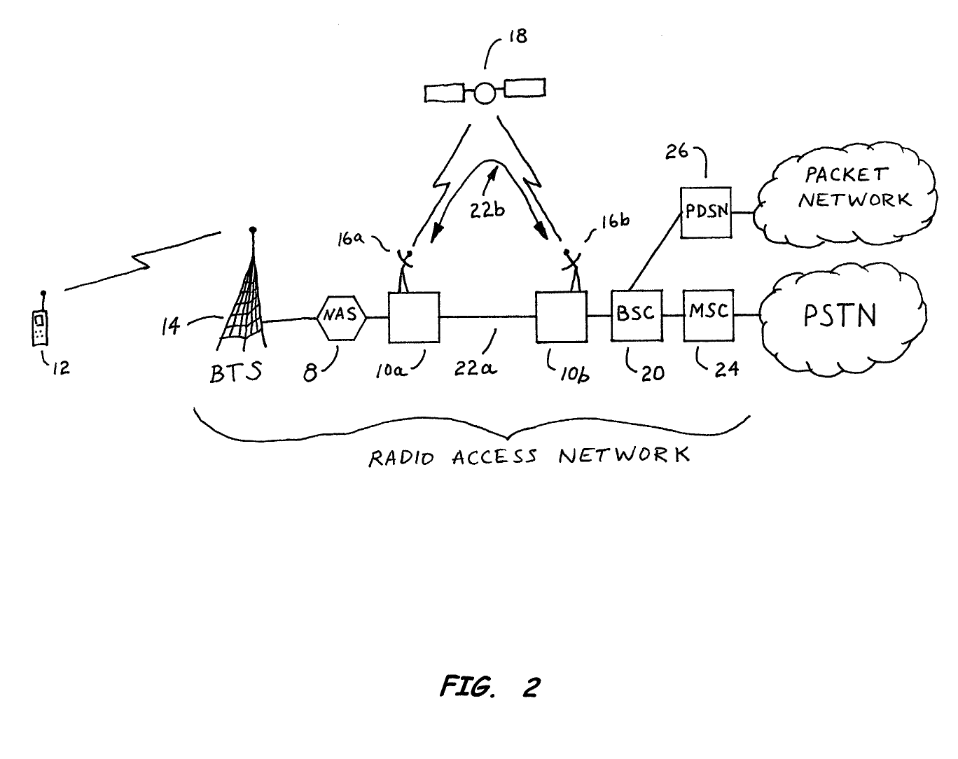

In an exemplary embodiment of the present invention as shown in FIG. 2, BTS 14 can be communicatively coupled to BSC 20 via multiple communication links, such as a first communication link 22a and a second communication link 22b. Like link 22, link 22a could be (or could include, without limitation), a copper wire, a fiber optic link, or a microwave link.

As will be described below, second communication link 22b may in some cases have some inherent delay that link 22a may not have.

Because of the delay that second communication link 22b could introduce, it may be desirable to use multilayer switches, such as switches 10a and 10b, to route signals through either link 22a or 22b, depending on the signal type. Switches 10a and 10b may perform layer 4 through layer 7 switching at wire speed. For example, switch 10a and 10b could be Nortel Networks' Alteon 180 series Web Switches, Foundry Networks' layer 2 through layer 7 Web Switches, or any other suitable multiplayer switches. Switches 10a and 10b could also be implemented by a microprocessor or other computer system; it is not necessary that they be multilayer switches.

Switches 10a and 10b may, in turn, be communicatively coupled to wireless transceivers 16a and 16b, respectively. Although devices 10a, 10b, 16a, and 16b are shown as discrete units, their functions could also be implemented in conjunction with other components, in any suitable combination and location. For example, the various functions of devices 10a, 10b, 16a, and 16b could easily be implemented using one or more components that integrate several functions of the devices while still providing the functionality of the stand-alone devices. Further, since the invention may use a processor or processors to carry out some functions, those functions may be carried out on a computer or processor that is communicatively coupled to, but physically distinct from, other components used to carry out the desired functions.

Signals entering switch 10a or switch 10b may use TCP/IP protocol or another network protocol, such as address resolution protocol (ARP), internet control message protocol (ICMP), user datagram protocol (UDP), etc. The data from BTS 14 may be converted to TCP/IP by a network access server (NAS) such as NAS 8. By examining the higher-level protocol layers of various signals (for example, open systems interconnection (OSI) model layers 4 through 7), switch 10a or 10b can determine whether a signal is delay sensitive. Alternatively, switch 10a or 10b could detect any other signal parameters that may indicate whether a signal is delay sensitive, such as a service option parameter contained in an origination message as defined by TIA/EIA-95 or TIA/EIA/IS-2000. If a signal is not delay sensitive, it may be switched onto second communication link 22b.

As shown in FIG. 2, second communication link 22b may be comprised of wireless transceivers 16a, 16b, and communications satellite 18. Communications satellite 18 may be a conventional, geosynchronous satellite or it may be a low-earth orbit satellite, such as an unused Iridium® satellite. Although satellite communications links may be somewhat expensive, it is likely that communications providers with sufficient traffic will be able to negotiate for services at rates that would make using a satellite or satellites financially competitive with constructing or leasing additional dedicated transmission lines. This is especially true as providers offer more services (which require more capacity) such as wireless web-browsing to their customers.

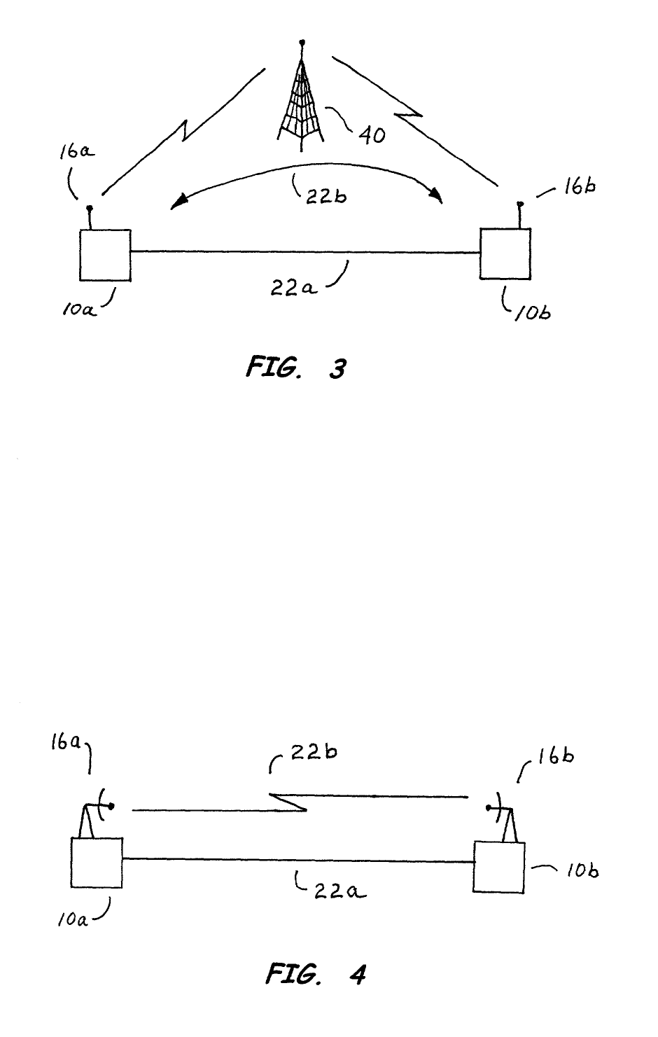

As shown in FIG. 3, link 22b may include a multichannel multipoint distribution service (MMDS) path that uses an MMDS omnidirectional antenna 40, as an alternative to satellite 18. As another alternative, shown in FIG. 3, link 22b may include a point-to-point microwave link. Thus, the physical nature of second communication link 22b is not necessarily critical to the proper functioning of the system; once a signal has been transmitted and received via wireless transceivers 16a and 16b and switched back into the telecommunications network, the operation of the system is transparent.

Once a signal arrives at BSC 20, it may be routed appropriately (depending on the type of signal it is) to a packet data serving node such as PDSN 26 and then to a packet-switched network, such as the Internet. The signal could also be routed to MSC 24 and from MSC 24 to the public-switched telephone network (PSTN).

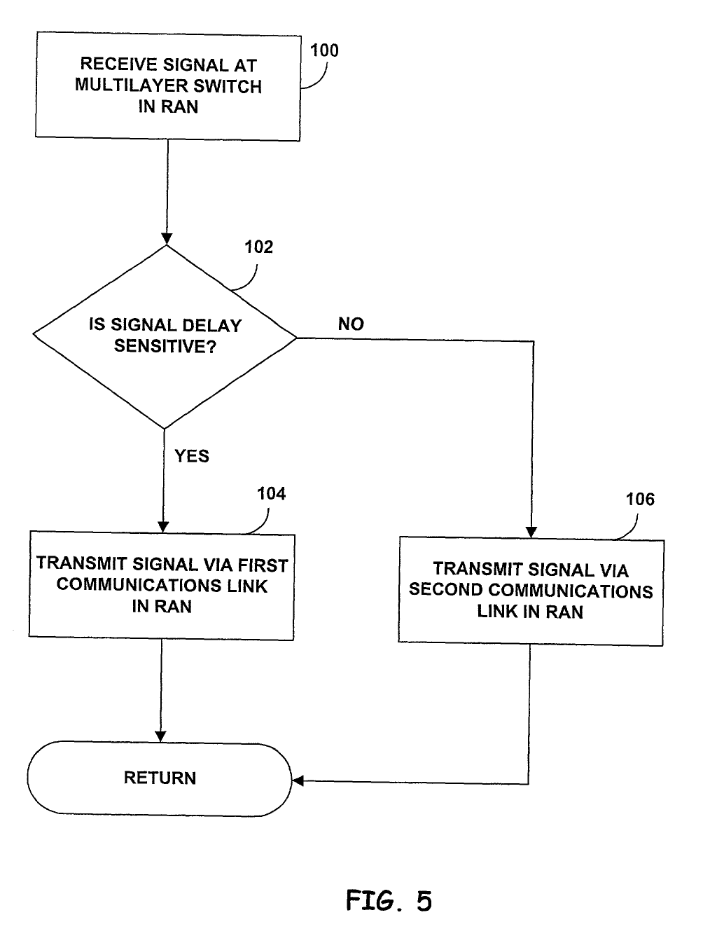

FIG. 5 illustrates a set of functions that may be involved in an exemplary embodiment of the present invention where communications signals that travel through a RAN are received at a switch or other communications management device, such as switch 10a or 10b. As shown at step 100, a signal, either a delay-sensitive or a non-delay-sensitive signal, may be received at switch 10a or 10b. The signal may be travelling from RAN node NAS 8 toward RAN node BSC 20, or it may be travelling in the opposite direction; the functioning of the system can be the same in either case.

Next, a switch may be used to determine if the received signal is delay-sensitive or non delay-sensitive, as shown at step 102. If it is determined that the received signal is delay-sensitive, it may be transmitted via a first communications link, as shown at step 104. If the signal is determined to be non delay-sensitive, it may be transmitted via a second communications link as shown at step 106.

As one example, a user of the system may initiate a data-only communication session from mobile station 12. Switch 10a or 10b may then filter any resulting signal by recognizing that, based on some property or properties of the signal, the endstation application is a one-way data-only application—i.e., a non delay-sensitive application. Thus, the signal may be appropriately transmitted from BTS 14 to BSC 20, or from BSC 20 to BTS 14, via the second communication link 22b.

It is not necessarily critical to all embodiments of the invention that switch 10a or 10b are multilayer switches, or that they route signals based on information contained in any particular OSI layer. For example, switch 10a or 10b could make routing determinations based on information contained in any protocol layer, either alone or in combination with other layers, or they could make routing determinations based on deep IP packet inspection to determine the type of data being transmitted from the payload.

If, instead of initiating a one-way data call the user were to initiate a voice call or an interactive data call (i.e., a delay-sensitive call), switch 10a or 10b could route any signal associated with that call by recognizing that the endstation application (e.g., a voice call) is delay-sensitive. Alternatively, switch 10a or 10b could be configured to detect a service option as defined by TIA/EIA-95 or TIA/EIA/IS-2000 to determine whether the call is a voice call or a data call, and transmit the signal via the desired link based on the determination. If the call is a voice call, the signal could be transmitted from BTS 14 to BSC 20, or from BSC 20 to BTS 14, via the first communication link 22a.

Exemplary embodiments of the present invention have been illustrated and described. It will be understood, however, that changes and modifications may be made to the invention without deviating from the spirit and scope of the invention, as defined by the following claims.

I claim:

1. A method for managing communications between a first node in a radio access network and a second node in the radio access network, wherein communication normally flows between the first node and the second node via a first communication link, the method comprising:
making a determination that a signal to be transmitted between the first node and the second node is a particular type; and
in response to the determination, transmitting the signal via a second communication link between the first node and the second node instead of via the first communication link.

2. The method of claim 1, wherein the first node comprises a BTS.

3. The method of claim 1, wherein the second node comprises a BSC.

4. The method of claim 1, wherein the determination is made regarding a signal that is to be transmitted from the first node to the second node.

5. The method of claim 1, wherein the determination is made regarding a signal that is to be transmitted from the second node to the first node.

6. The method of claim 1, wherein the second communication link comprises a wireless communication link.

7. The method of claim 1, wherein the second communication link comprises a satellite communication link.

8. The method of claim 1, wherein the second communication link comprises a multichannel multipoint distribution service (MMDS) link.

9. The method of claim 1, wherein the second communication link comprises a terrestrial microwave link.

10. A method for managing communications between a BTS in a radio access network and a BSC in the radio access network, wherein communication normally flows between the BTS and the BSC via a first communication link, the method comprising:
making a determination at the BTS that a signal to be transmitted between the BTS and the BSC is a non delay-sensitive signal; and
in response to the determination, transmitting the signal via a second communication link comprising a communication satellite between the BTS and the BSC instead of via the first communication link.

11. A system for managing communications between a first node in a radio access network and a second node in the radio access network, the system comprising:
a first communication link comprising a dedicated transmission line;
wherein communication normally flows between the first node and the second node via the first communication link, and wherein the communication defines a type of a signal;
a first switch that uses the type of the signal as a basis to decide whether to route the communication via the first communication link or via a second communication link; and
a second switch that uses the type of the signal as a basis to decide whether to route the communication via the first communication link or via the second communication link.

12. The system of claim 11, wherein the second communication link comprises a wireless communication link.

13. The system of claim 11, wherein the second communication link comprises a satellite communication link.

14. The system of claim 11, wherein the second communication link comprises a multichannel multipoint distribution service (MMDS) link.

15. The system of claim 11, wherein the second communication link comprises a terrestrial microwave communication link.

16. The system of claim 11, wherein the first node comprises a BTS.

17. The system of claim 11, wherein the second node comprises a BSC.

18. The system of claim 11, wherein the first switch comprises a multilayer switch.

19. The system of claim 11, wherein the second switch comprises a multilayer switch.

20. A system for managing communications between a BTS in a radio access network and a BSC in the radio access network, the system comprising:
a first communication link comprising a dedicated transmission line;
wherein a communication normally flows between the BTS and the BSC via the first communication link, and wherein the communication defines a type of a signal;
a first switch that uses the type of the signal as a basis to decide whether to route the communication via the first communication link or via a second communication link; and
a second switch that uses the type of the signal as a basis to decide whether to route the communication via the first communication link or via the second communication link.
